(19) United States
(12) Patent Application Publication
(10) Pub. No.: US 2012/0143505 A1
(43) Pub. Date: Jun. 7, 2012

(54) Method And Device For Determining An Optimal Flight Trajectory Followed By An Aircraft

(75) Inventors: Andrea Giovannini, Toulouse (FR); Thomas Pastre, Caluire et Cuire (FR)

(73) Assignee: AIRBUS OPERATIONS (S.A.S.), Toulouse Cedex (FR)

(21) Appl. No.: 13/309,150

(22) Filed: Dec. 1, 2011

(30) Foreign Application Priority Data
Dec. 7, 2010 (FR) 10 60191

(51) Int. Cl. G01C 21/00

(52) U.S. Cl. 701/540

(57) ABSTRACT

Method and device for determining an optimal flight trajectory followed by an aircraft.

The device (1) includes means (8, 9) for determining an optimal flight trajectory, which is free of collision with obstacles, which respects constraints of energy, and which links the current position of the aircraft to a target point defined by an operator.

The present invention relates to a method and a device for determining an optimum flight trajectory to be followed by an aircraft, in particular a transport airplane.

More particularly, the present invention aims at generating, using on-board means, real time optimized trajectories, to be flown in constrained dynamic environments, that is in environments that are able to contain objects (or obstacles), with which the aircraft should prevent from colliding, and including mobile objects such as meteorological disturbance areas, for instance, stormy areas, or other aircrafts.

It is known that managing the flight trajectory of an aircraft is generally to be carried out by an on-board system for managing the flight. Modifying a flight plane, more specifically, is often a tricky method, requiring multiple interactions with systems of the aircraft, the final result of which is not completely optimized. This is more specifically caused, on the one hand, to difficulties and limitations inherent to the use of published lanes and procedures and, on the other hand, to limitations of already existing functions for generating unpublished trajectories (for example <<DIR TO>>).

Currently, there is no on-board means enabling to generate, in real time, in a simple way, optimum trajectories being independent from existing lanes and being free from obstacles, including of the dynamic type.

The present invention aims at solving these drawbacks. It relates to a method for determining an optimum flight trajectory for an aircraft, in particular a transport airplane, being defined in an environment able to contain mobile obstacles, said flight trajectory comprising a lateral trajectory and a vertical trajectory and being defined between a current point and a target point.

According to the invention, said method is remarkable in that, automatically, by means at least of one data base relative to obstacles and a reference vertical profile, taking into account an objective determined by an operator and indicating at least said target point:

A/at least one first section of flight trajectory is determined from said current point, carrying out the following successive operations:
a) at least one straight line segment with a predetermined length, starting at said current point is generated;
b) a trial for validating each thus generated straight line segment is carried out, a validation trial using said data base and said reference vertical profile;
c) each generated and validated straight line segment is evaluated, giving it a score being representative of its ability to meet the set objective; and
d) each straight line segment, with the score being given to it is registered as a section of flight trajectory illustrating a virtual trajectory;

B/an iterative processing (or iterative loop) is implemented, comprising the following successive operations:
a) amongst the recorded virtual trajectories, the virtual trajectory having the best score with respect to the set objective is taken into consideration;
b) possible heading changes are determined from the downstream end of this virtual trajectory;
c) for each one of the possible heading changes, a section of trajectory is generated, starting at said downstream end and comprising at least one of the following elements: one circle arc and one straight line segment, for which a validation trial is carried out;
d) for each generated and validated section of trajectory at step c) a new section of flight trajectory is formed, made up of the virtual trajectory taken into consideration at step a); followed by said section of trajectory;
e) each thus formed section of trajectory is evaluated, giving it a score being representative of its ability to reach the set objective; and
f) each new section of flight trajectory illustrating a virtual trajectory, with the score given to it is registered;
   the previous sequence of steps a) to f) being repeated until the downstream end of the virtual trajectory having the best score at the end of a repetition (of said steps a to f) corresponds to said target point, this virtual trajectory then representing the optimum flight trajectory; and

C/this optimum flight trajectory is transmitted to user means.

The operations described in A/and B/can generally be implemented in both ways, that is from the aircraft to the target point and vice-versa.

Thus, thanks to the present invention, a 4D flight trajectory is generated in real time, having the following characteristics, as further detailed hereinafter:
it is optimized;
it is free from any collision with surrounding obstacles, including mobile obstacles;
it meets energy constraints; and
it represents a flight trajectory for linking the current position (or current point) of the aircraft to a target point defined by an operator, generally the pilot of the aircraft. This target point could, for instance, correspond to the threshold of the selected runway or to a stationary point on a usual STAR or APPR procedure for approach uses or even a meeting point of an initial flight plane.

The method according to the present invention is different from a usual processing carried out by a system for managing a flight, by its ability to provide an optimum trajectory independent from existing lanes, and by the simplicity of the actions leading to the generation of the trajectory, as detailed below. Moreover, said method ensures that the obtained trajectory is free from including dynamic obstacles (such as a stormy area or an aircraft), a performance that could not be provided by a flight managing system.

Moreover, the present invention is able to manage flight operational constraints in a minimum time, and it further provides optimized flying trajectories, on the basis of a processing of information generated by the flight managing system. The processing of such information allows complex constraints to be integrated, without managing the mathematical complexity in algorithms.

Thus, the method according to this invention provides, more specifically, the following advantages:
it allows to support the crew in taking a decision on board. The method for generating a trajectory aims at reducing the workload of the crew in situations considered as complex on board. Such situations are associated with a high workload of the pilot, due including to a change of environment (change of runway in the approach phase for instance). The method for generating a trajectory is then involved implementing the thinking load associated with the decision taken regarding the trajectory, the pilot acting as the operator of the function and for validating the result. The method generates an optimum trajectory, free of any obstacle and meeting operational constraints, being supplied to user means. This optimum trajectory could, more particularly, be displayed on an on-board screen or be transmitted to an air traffic controller. It could also be used as a reference for the autopilot;
it enables to validate a trajectory. The method for generating a trajectory simultaneously takes into consideration a plurality of constraints (ground, energy, flight physics, . . . ). The pilots could make use of said generating method for validating a trajectory they wish to follow (but they are unable to check the validity thereof as a result of too a complex environment); and
it allows to generate a trajectory integrating pilots into the generation loop. The main use relies on the method without requiring particular parameters: the method generates an optimum trajectory on the basis of default parameters, being associated with the aircraft and the environment thereof. The crew can, however, orient and impose particular constraints for refining the trajectory or better meet a specific need, for instance generating a trajectory with a wider coverage area than that imposed by the navigation accuracy so as to increase the passage margins with respect to obstacles. Such an implementation can be used when by-passing a moving stormy area for instance, for overcoming variations of the environment.

Furthermore, advantageously, at step A/a), the altitude of the straight line segment is determined through said reference vertical profile.

Moreover, advantageously, for carrying out a validating trial for a section of trajectory:
a protective shell is determined around said section of trajectory, preferably a protective shell relative to required navigation performance of the RNP type (<<Required Navigation Performance>>);
such a protective shell is compared to obstacles from said data base(s) relative to obstacles; and
said section of trajectory is considered to be valid if no obstacle is located in said protective shell.

Moreover, advantageously, for carrying out a trial for validating a section of trajectory with respect to mobile obstacles, the protective shell is compared to extrapolated positions of these mobile obstacles.

Furthermore, advantageously, for evaluating a section of trajectory:
the distance remaining to be followed from the downstream end of said section of trajectory, for reaching the target point is determined;
the difference of heading is determined between the heading at said downstream end and a target heading at said target point; and
a score is attributed to said section of trajectory, as a function of said distance and of said difference of heading. This score illustrates the ability of the section of trajectory to meet the set objective, that is to allow the aircraft if it follows this section of trajectory to rapidly reach said target point while having then a heading close to the target heading.

Moreover, advantageously, at step B/b), for determining the possible changes of heading from the downstream end of the virtual trajectory all the successive headings are taken into consideration, according to a predetermined pitch, from the current heading at said downstream end, for instance 10°, up to a maximum heading (for instance 170° from the current heading), and this on either side of said current heading.

Furthermore, advantageously:
at step B/c), for generating a section of trajectory:

c1) first a circle arc is generated as a function of the speed at said downstream end, and a trial is carried out for validating this circle arc; then

c2) a straight line segment is generated, associated with this circle arc, and a trial for validating the section of trajectory is carried out, comprising the circle arc and the straight line segment;

at step B/c1), a circle arc is determined, having the smallest radius able to be followed by the aircraft flying at a predictive speed; and/or

at step B/c), a straight line segment is determined similarly to the straight line segment generated at step A/a).

The present invention also relates to a device for determining an optimum flight trajectory for an aircraft, in particular a transport airplane, being defined in an environment able to contain mobile obstacles, said flight trajectory comprising a lateral trajectory and a vertical trajectory and being defined between a current point and a target point.

According to this invention, said device is remarkable in that it comprises:
at least one data base relative to obstacles;
first means allowing an operator to enter an objective indicating at least said target point;
second means for determining at least one first section of flight trajectory from said current point, said second means comprising:
   one element for generating at least one straight line segment with a predetermined length starting at said current point;
   one element for carrying out a trial for validating each thus generated straight line segment, a validating trial using said data base relative to obstacles and a reference vertical profile;
   one element for evaluating each generated and validated straight line segment, giving it a score being representative of its ability to reach the set objective;
   one element for recording, in a storing means, each section of flight trajectory illustrating a virtual trajectory, with its score;
third means for implementing an iterative processing, said third means comprising:
   one element for taking into consideration, amongst all the virtual trajectories recorded in the storing means, the virtual trajectory having the best score with respect to the set objective;
   one element for determining possible heading changes from the downstream end of this virtual trajectory;
   one element for generating, for each one of the possible heading changes, a section of trajectory starting at said downstream end and comprising at least one of the following elements: a circle arc and a straight line segment, for which a validation trial is carried out;
   one element for forming, for each generated and validated section of trajectory, a new section of flight trajectory made up of said virtual trajectory followed with said section of trajectory;
   one element for evaluating each thus formed new section of trajectory, giving it a score being representative of its ability to reach the set objective;
   one element for recording, in the storing means, each new section of flight trajectory illustrating a virtual trajectory, with the score being given to it;
      said third means repeating the string of previous iterations until the downstream end of the virtual trajectory having the best score at the end of an iteration corresponds to said target point, this virtual trajectory then representing the optimum flight trajectory; and
fourth means for transmitting this optimum flight trajectory to user means.

Consequently the device according to this invention allows to quickly provide a flight trajectory, taking into consideration all the operational needs associated with implementing aircrafts, without relying on a discretization of space references.

Additionally, advantageously:
said user means comprise a viewing screen of the aircraft, for displaying said optimum flight trajectory; and/or
said fourth means comprise means for transmitting said optimum flight trajectory to means external to said device, in particular to on-board systems such as an autopilot system for instance or to means located outside the aircraft, including for informing the air traffic control.

Furthermore, advantageously, the device according to this invention both comprises:
one ground data base representing stationary constraints;
one weather data base. Such information could be issued from the on-board weather monitoring or be received via a usual data transmission link; and
one data base relative to surrounding aircrafts, containing flight planes and predictions from aircrafts being identified in a given area.

In addition to information issued from said data bases, the device according to this invention relies, amongst others, on the following information:
one set of parameters configured by the pilot or set to default values. The only information being necessary for implementing the method is the target point (that is the point where the pilot wishes that the generated trajectory ends). This target point is defined by a geometric position (latitude, longitude, altitude, heading), but also potentially by auxiliary constraints (speed, configuration, . . . ). The most current target point in an approach phase is the threshold of the runway or a meeting point during a standard arrival procedure; and
one vertical profile generated by the flight managing system for providing a descent reference for the aircraft. The vertical profile associates with each distance compared to the target point one altitude and one speed.

The present invention further relates to an aircraft, in particular a transport airplane, comprising a device such as mentioned hereinabove.

The FIGS. of the appended drawing will better explain how this invention can be implemented. In these FIGS., like reference numerals relate to like components.

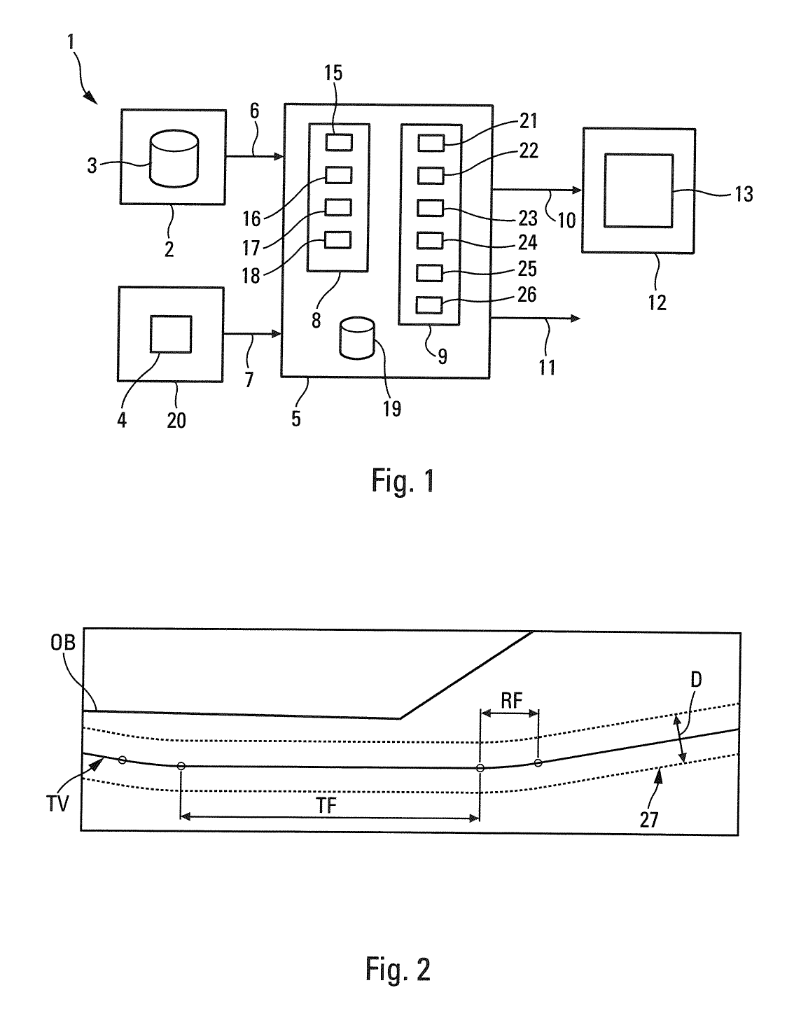

FIG. 1 is a block diagram of a device according to the invention.

FIGS. 2 to 4 are diagrams for explaining the generation according to this invention of an optimum flight trajectory.

The device 1 according to this invention and schematically shown on FIG. 1, aims at determining a flight trajectory TV to be followed by an aircraft (not shown), in particular a transport airplane, in an environment able to contain obstacles (including mobile obstacles). Said flight trajectory TV comprises a lateral (or horizontal) trajectory being defined in a horizontal plane and a vertical trajectory being defined in a vertical plane. It is formed so as to link a current point P0 (corresponding to the current position of the aircraft) to a target point Pc.

According to this invention, said device comprises:
one set 2 of data base(s) 3 relative to obstacles;
one set 20 of sources of information, comprising, amongst others, means 4 allowing an operator to enter in the device 1 an objective indicating at least said target point Pc;
one processing unit 5 being connected via links 6 and 7 respectively to said sets 2 and 20 and comprising means 8 for determining a first section of flight trajectory T0 from the current point P0, as well as means 9 for implementing an iterative loop so as to form (via said first section T0) the optimum flight trajectory TV; and
means 10, 11 for transmitting this optimum flight trajectory TV to user means 12.

Moreover, according to this invention, said means 8 comprise:
one element for generating at least one straight line segment with a predetermined length starting at said current point P0;
one element 16 for carrying out a trial for validating each thus generated straight line segment, a validating trial using said data base 3 relative to obstacles as well as a reference vertical profile;
one element 17 for evaluating each generated and validated straight line segment giving it a score being representative of its ability to meet the objective set by the operator, more specifically a pilot of the aircraft; and
one element 18 for recording, in a usual storing means (memory) 19, as a section of flight trajectory T0 illustrating a virtual trajectory, each thus obtained straight line segment, with the score being given to it.

Moreover, according to this invention, said means 9 comprise:
one element 21 for taking into consideration, amongst all the virtual trajectories recorded in the storing means 19, the virtual trajectory having the best score with respect to the set objective;
one element 22 for determining possible heading changes from the downstream end of this virtual trajectory;
one element 23 for generating, for each one of the possible heading changes, a section of trajectory starting at said downstream end and comprising at least one of the following elements: a circle arc RF and a straight line segment TF, for which a validation trial is carried out;
one element 24 for forming, for each generated and validated section of trajectory, a new section of flight trajectory made up of said virtual trajectory followed with said section of trajectory;
one element 25 for evaluating each thus formed section of trajectory, giving it a score being representative of its ability to meet the objective set by the operator; and
one element 26 for recording, in the storing means 19, each new section of flight trajectory illustrating a virtual trajectory, with the score being attributed to it.

Moreover, said means 9 repeat the string of previous iterations (of said elements 21 to 26) until the downstream end of the virtual trajectory having the best score at the end of an iteration corresponds to said target point Pc, this virtual trajectory then representing the optimum flight trajectory TV.

The device 1 according to this invention thus allows to generate an optimum trajectory TV respecting parameters of configuration of the pilot and of energy constraints. The trajectory is built up from a structure RNP (succession of <<Track to Fix>> and <<Radius to Fix>> segments such as defined in ARINC424, and referred to as TF and RF in the present description). Generating a trajectory does not integrate any guiding or energy management laws directly in the processing: the respect of such constraints occurs through integrating the vertical profile in input (produced by the flight managing system) and integrating transition rules of the flight managing system. This approach allows the device 1 to generate flying trajectories without overloading the functions with hard to process data.

Said device 1 follows iterative logics, analyzing from a given point, the potential positions where the aircraft could fly respecting the constraints imposed by the pilot (via the means 4). The device 1 analyzes the different potential positions (referred to as virtual), giving it a score thanks to an internal evaluation function and sorts them in a list gathering all of said virtual positions. On the following iteration, the device 1 recovers the best known virtual position (best score in the list) and reiterates the loop (analysis of the potential adjacent positions, validation of produced segments of trajectory, recording of the new virtual position and insertion in the list). The research loop stops when the device 1 considers having found the best solution.

Subsequent criteria could, if necessary, be integrated into the calculation of the score, for instance the value of the wind component along the section of trajectory (if known or estimated).

The function implemented by the device 1 is based on a discrete representation of the research environment.

Preferably, the set 2 of data bases 3 of the device 1 simultaneously comprises:
one ground data base representing stationary constraints;
one weather data base. Such information could be issued from the on-board weather monitoring or be received via a usual data transmission link; and
one data base relative to surrounding aircrafts, containing flight planes and predictions from aircrafts identified in a given area.

The device 1 thus refers to types of data bases, to be separately processed:
one stationary data base, representing obstacles, the position of which is not altered during the flight. This base contains discretizations of obstacles. The representation is a ground polygonal projection associated with a threshold height; and
dynamic bases representing all the moving obstacles that the operator wishes to take into consideration in his evaluation. The dynamic bases integrate additional information regarding the progress of the areas. For stormy areas, the information is produced through analyzing the recent progress of areas (analysis of the weather monitoring or of data transmitted via a data transmission link for instance). The weather data base represents a discrete risk area associated with a cloudy area detected through monitoring. With each determining point of the risk area there is associated a shift vector calculated on the progress of the point during the last minutes of observation.

In addition to information issued from said data bases 3, the device 1 according to this invention relies, amongst others, on the following information:
one set of parameters configured by the pilot (using means 4) or on the basis of default values. The only information necessary for implementing this invention is the target point Pc (that is the point where the pilot wishes that the generated trajectory ends). This target point Pc is defined by a geometric position (latitude, longitude, altitude, heading), but also potentially by auxiliary constraints (speed, configuration, . . . ). The most current target point Pc in an approach phase is the threshold of the runway or a meeting point during a standard arrival procedure; and
one vertical profile generated by the flight managing system, providing a descent reference for the aircraft. The vertical profile (received for instance by the link 7) associates, with each distance compared to the target point Pc, an altitude and a speed.

Additionally:
said user means 12 comprise a viewing screen 13, on which said optimum flight trajectory TV can be displayed; and
the means 11 can transmit the optimum flight trajectory TV to means external to the device 1, in particular to on-board systems such as an autopilot system for instance, or even to means located outside the aircraft, including for informing the air traffic control (for instance via a usual data transmission link).

The first section of trajectory TO generated by the processing unit 5 comprises only one segment TF. The element 15 draws the ground projection of the segment TF as a function of interception parameters. The determination points do not inform about either the speed, or the altitude on the segment generated at this stage of determining. The analysis of the vertical profile by a sub-function allows to deduct the altitude associated with each point of determining of the segment TF. This is similar for predicting the speed. Once the virtual segment being plotted in 3D, the element 15 generates around the trajectory TV a protective shell 27 relative to required navigation performance of the RNP type (>>Required Navigation Performance<<), as shown on FIG. 2.

The protective shell 27 is defined around the trajectory TV, both on the horizontal plane (FIG. 2: width D) as well as on the vertical plane.

The element 16 then trials a 3D collision between this protective shell 27 and the stationary obstacles OB being known and stored in a data base. Detecting a collision 4D with dynamic areas occurs through linearly extrapolating positions, on the basis of the vectors being stored in the corresponding data base. The element 16 considers that said section of trajectory TF is validated if no obstacle OB is present in said protective shell 27.

In the case where a section of trajectory is validated, the element 17 carries out the evaluation of the new virtual position associated with the validated segment TF. This is a function analyzing the interest of a virtual position with respect to the objective set by the pilot. In the case of an optimization in the distance being covered, the function evaluates the distance covered for reaching the evaluated virtual position and estimates the distance still to be covered for reaching the target point Pc. Such an assessment is based on a measurement of the distance between the virtual point and the target point Pc. Preferably, the evaluation of a section of trajectory does not only relate to the distance, but also to the convergence of headings between the current heading and the target heading Cc (at the target point Pc), this factor weighting the overall evaluation. The addition of these two values gives an overall score without unity representing the interest of the considered position, as explained below.

Afterwards, the element 18 records in the storing means 19 this section of flight trajectory illustrating a virtual trajectory, with the score that has been given to it by the element 17.

Once this first virtual element T0 being created, the means 9 implement the iterative processing loop. This loop is active as long as the means 9 have not generated any trajectory considered as optimum by the evaluation function.

The means 9 therefore follow iterative processing logics. At each passage of the loop, they search for (with the help of the element 21) the best position that has been generated until then and analyze the possibilities of propagation from this position. Said possibilities of propagation represent all the future positions where the aircraft could be located at an iteration n+1 from its current position at an iteration n.

To this end, the element 21 thus scans the storing means 19 for recovering therein the best score. This score is associated with an incomplete trajectory and a current virtual position. This virtual position will be used as a reference throughout the whole iteration of the loop, as the starting point of the propagation.

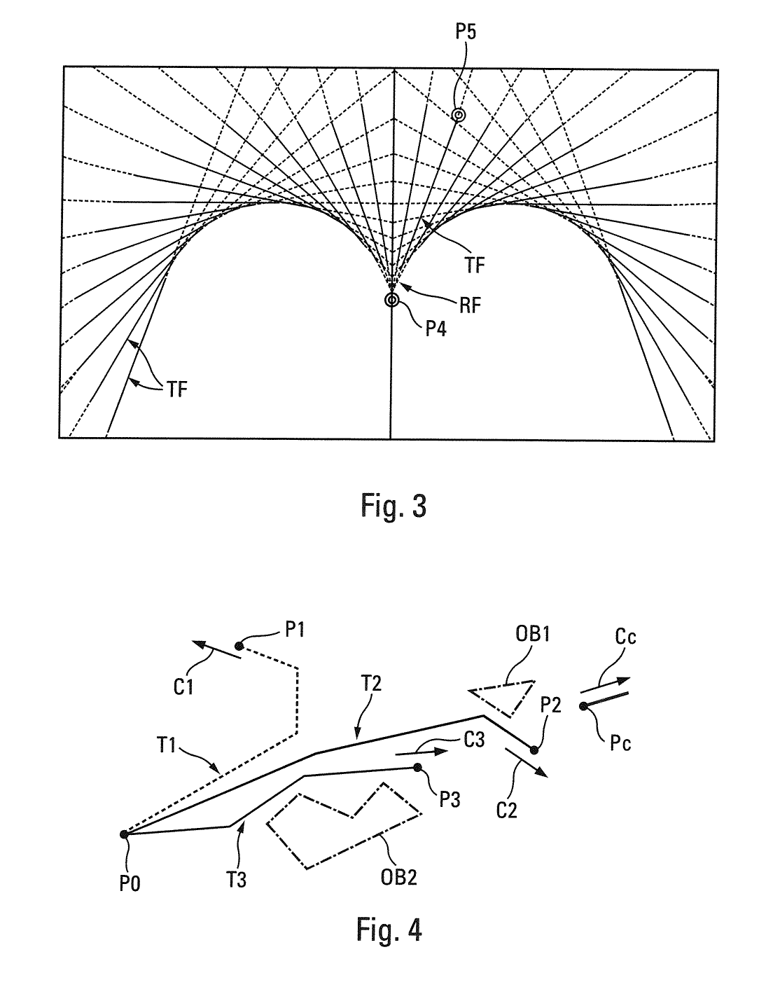

Afterwards, the element 22 analyzes the possible heading changes (as a function of parameters of configuration of the pilot) at the point recovered by the element 21, preferably in the shape of a discretization of the potential heading changes. As an example, a 10° discretization could be used for the heading change. The operator could also define, using means 20, the minimum and maximum heading changes he wishes to implement on a trajectory. Thus, the analysis of the possible heading changes comprises observing the shifting possibilities taking into consideration such parameters. As an example, for a configuration of 10° discretization and a 170° maximum heading change, the element 22 identifies 35 different cases (−170°, −160°,. . . , −10°, 0, +10°, +20°, . . . , +160°, +170°, as shown on FIG. 3.

Consequently, for determining the possible heading changes from the downstream end of the virtual trajectory (having the best score), the element 22 takes into consideration, from the current heading at said downstream end, all the successive headings, according to a predetermined pitch, for instance 10°, and this up to a maximum heading (for instance 170° of the current heading). This consideration is achieved on either side of said current heading.

With each potential heading change, a new change of direction of the trajectory is associated. The following steps are implemented for each one of the acceptable heading changes.

For each of such heading changes, the element 23 comprises means for carrying out the following successive operations, as further detailed hereinafter:
generation of a segment RF as a function of the speed prediction at the current point:
   generation of a 2D segment RF;
   update of the speed and altitude information on the segment RF, based on the vertical profile;
   generation of protective shells RNP on the segment RF;
   4D collision trials; and
   validation of the segment RF; and
generation of a segment TF associated with the validated segment RF:
   generation of a 2D segment TF;
   update of the speed and altitude information;
   generation of protective shells RNP on the segment TF;
   4D collision trials; and
   validation of the segment TF.

For forming a new section of trajectory, the element 23:
thus first generates a circle arc RF as a function of the speed at said downstream end, and carries out a trial for validating this circle arc RF. Preferably, the element 23 determines a circle arc RF having the smallest radius able to be followed by the aircraft flying at a predicted speed; then
generates a straight line segment TF associated with this circle arc RF, and carries out a trial for validating the section of trajectory formed by the circle arc RF followed by the straight line segment TF.

With each point recovered in the storing means 19 (for instance the point P4 on FIG. 3) a speed prediction and a (3D) geometric position are associated. The speed prediction thus allows the element 23 to generate a bending radius at the estimated speed, so that the aircraft is able to fly along the segment RF being considered. The element 23 creates the circle arc RF the most adapted (that is preferably the smallest flying one) to the predicted speed.

The segment RF is first formed in 2D by the element 23. The information relative to the vertical profile allow for the calculation of altitudes on each point of the curve. The element 23 then forms the protective shell of the RNP type for the segment RF. 3D and 4D collision trials are carried out on an overprotective discretization of the surface associated with the segment RF being generated.

The following phase of generation of a segment TF is identical to that implemented by the element 15. The element 23 generates a segment TF starting from the ending point of the validated segment RF. The segment TF is built, tested and validated.

At this stage of the iteration, the virtual trajectories generated by the algorithm and stored in the storing means 19 have the structure (heading changes from −170° to +170° shown on FIG. 3.

The element 25 carries out an evaluation of the virtual position associated with the combination RF-TF (point P5 with a +20° heading change for the example of FIG. 3). The new position is scored for the evaluation function and stored in the storing means 19.

The example of FIG. 4 shows, as an illustration, a situation with three virtual trajectories T1, T2 and T3 (that should avoid the obstacles OB1 and OB2). In such a case:
the virtual trajectory T1 has the worst score, being the result, amongst others, of the downstream end P1 (with a heading C1) being far from the objective (target point Pc) despite the fact that the already followed journey is long;
the virtual trajectory T2 has an intermediary score, as it is closer to the goal (target point Pc) and has followed a nearly direct trajectory. However, as a result of the obstacle OB1, the element 25 analyzes the bypass possibilities, and T2 has a diverging heading C2 (at the downstream end P2) compared to the target point Pc; and
the virtual trajectory T3 has the best score. Although the downstream end P3 is even further spaced apart from the target point Pc, the simultaneous consideration of the distance being followed, the estimation of the remaining distance and of its heading C3 results in that the element 25 considers that the virtual trajectory T3 is the most interesting one.

The main generation loop is completed after this new position is inserted in the storing means 19. Upon the following iteration of the loop, the means 9 check whether the best scored virtual position (amongst those stored) corresponds to the target point Pc entered by the pilot. If this is the case, the means 9 stop the main loop as the virtual trajectory then links the point PO to the target point Pc.

The means 9 thus repeat the string of previous iterations until the downstream end of the virtual trajectory having the best score at the end of an iteration corresponds to said target point Pc, this virtual trajectory then representing the optimum flight trajectory TV.

Consequently, the device 1 according to the present invention generates, in real time, a 4D flight trajectory TV, having the following characteristics:
it is optimized;
it is free from any collision with surrounding obstacles OB, OB1, 0B2, including mobile obstacles;
it respects constraints of energy; and
it represents a flight trajectory allowing to link the current position (or current point P0) of the aircraft to a target point Pc defined by an operator, generally the pilot of the aircraft. This target point Pc could, for instance, correspond to the threshold of the selected runway or to a stationary point on a usual STAR or APPR procedure for approach uses or even a meeting point of an initial flight plane.

As set forth above, the thus obtained optimum flight trajectory TV can, amongst others, be displayed on an on-board screen 13 or be transmitted to an air traffic controller. It could also be used as a reference for an autopilot.

1. A method for determining an optimum flight trajectory for an aircraft, in particular a transport airplane, said flight trajectory (TV) comprising a lateral trajectory and a vertical trajectory and being defined between a current point (PO) and a target point (Pc),
characterized in that, automatically, by means at least of one data base (3) relative to obstacles (OB) and a reference vertical profile, taking into account an objective set by an operator and indicating at least said target point (Pc):
A/at least one first section of flight trajectory is determined from said current point (PO), carrying out the following successive operations:
a) at least one straight line segment is generated, with a predetermined length, starting at said current point (P0);
b) a trial for validating each thus generated straight line segment is carried out, a validation trial using said data base (3) and said reference vertical profile;
c) each generated and validated straight line segment is evaluated, giving it a score being representative of its ability to meet the set objective; and
d) each straight line segment, with the score being given to it is registered as a section of flight trajectory illustrating a virtual trajectory;
B/an iterative processing is implemented, comprising the following successive operations:
a) amongst all the recorded virtual trajectories, the virtual trajectory having the best score with respect to the set objective is taken into consideration;
b) possible heading changes are determined from the downstream end of this virtual trajectory;
c) for each one of the possible heading changes, a section of trajectory is generated, starting at said downstream end and comprising at least one of the following elements: a circle arc (RF) and a straight line segment (TF), for which a validation trial is carried out;
d) for each generated and validated section of trajectory at step c), a new section of flight trajectory is generated, made up of the virtual trajectory taken into consideration at step a); followed by said section of trajectory;
e) each new thus generated section of trajectory is evaluated, giving it a score being representative of its ability to reach the set objective; and
f) each new flight section of trajectory illustrating a virtual trajectory with the score given to it is registered;
the previous string of steps a) to f) being repeated until the downstream end of the virtual trajectory having the best score at the end of a repetition corresponds to said target point (Pc), this virtual trajectory then representing the optimum flight trajectory (TV); and
C/this optimum flight trajectory (TV) is transmitted to user means (12).

2. The method according to claim 1,
characterized in that at step A/a), the altitude of the straight line segment is determined using said reference vertical profile.

3. The method according to claim 1,
characterized in that, for carrying out a trial for validating a section of trajectory:
a protective shell (27) is determined around said section of trajectory;
this protective shell (27) is compared to obstacles (OB) issued from said data base (3) relative to obstacles; and
said section of trajectory is considered to be validated if no obstacle (OB) is located in said protective shell (27).

4. The method according to claim 3,
characterized in that, for carrying out a trial for validating a section of trajectory with respect to mobile obstacles, the protective shell (27) is compared to extrapolated positions of these mobile obstacles.

5. The method according to claim 1,
characterized in that to evaluate a section of trajectory (T1, T2, T3):
the distance remaining to be covered from the downstream end (P1, P2, P3) of said section of trajectory, for reaching said target point (Pc) is determined;
the heading difference is determined between the heading (C1, C2, C3) at said downstream end (P1, P2, P3) and a heading target (Cc) at said target point (Pc); and
a score is given to said section of trajectory (T1; T2, T3) as a function of said distance and of said difference of heading.

6. The method according to claim 1,
characterized in that, at step B/b), for determining the possible changes of heading from the downstream end of the virtual trajectory, all the successive headings are taken into consideration, according to a predetermined pitch, from the current heading at said downstream end to a maximum heading, and this, on either side of said current heading.

7. The method according to claim 1,
characterized in that at step B/c), for generating a section of trajectory:
c1) a circle arc (RF) is generated as a function of the speed at said downstream end, and a trial is carried out for validating this circle arc; then
c2) a straight line segment (TF) is generated, associated with this circle arc (RF), and a trial is carried out for validating the section of trajectory comprising the circle arc (RF) and the straight line segment (TF).

8. The method according to claim 7,
characterized in that at step B/c1), a circle arc (RF) is determined, having the smallest radius able to be followed by the aircraft flying at a predicted speed.

9. The method according to claim 1,
characterized in that at step B/c), a straight line segment (TF) is determined similarly to the straight line segment generated at step A/a).

10. A device for determining an optimum flight trajectory for an aircraft, in particular a transport airplane, said flight trajectory (TV) comprising a lateral trajectory and a vertical trajectory and being defined between a current point (PO) and a target point (Pc),
characterized in that it comprises:
at least one data base (3) relative to obstacles (OB);
first means (4) allowing an operator to enter an objective indicating at least said target point (Pc)
second means (8) for determining at least one first section of flight trajectory from said current point (PO), said second means (8) comprising:
one element (15) for generating at least one straight line segment with a predetermined length starting at said current point (PO);
one element (16) for carrying out a trial for validating each thus generated straight line segment, a validating trial using said data base relative to obstacles and a reference vertical profile;
one element (17) for evaluating each generated and validated straight line segment, giving it a score being representative of its ability to reach the set objective;
one element (18) for recording, in a storing means (19), each section of flight trajectory illustrating a virtual trajectory, with its score;
third means (9) for implementing an iterative processing, said third means (9) comprising:
one element (21) to take into account, amongst all the virtual trajectories recorded in the storing means (19), the virtual trajectory having the best score with respect to the set objective;
one element (22) for determining possible heading changes from the downstream end of this virtual trajectory;
one element (23) for generating, for each one of the possible heading changes, a section of trajectory starting at said downstream end and comprising at least one of the following elements: a circle arc (RF) and a straight line segment (TF), for which a validation trial is carried out;
one element (24) for forming, for each generated and validated section of trajectory, a new flight section of trajectory consisting in said virtual trajectory followed with said section of trajectory;
one element (25) for evaluating each new thus formed section of trajectory, giving it a score being representative of its ability to reach the set objective;
one element (26) for recording, in the storing means (19), each new flight section of trajectory illustrating a virtual trajectory, with the score being given to it;
said third means (9) repeating the string of previous iterations until the downstream end of the virtual trajectory having the best score at the end of an iteration corresponds to said target point (Pc), this virtual trajectory then representing the optimum flight trajectory (TV); and
fourth means (10, 11) for transmitting this optimum flight trajectory (TV) to user means (12).

11. The device according to claim 10,
characterized in that it further comprises said user means (12) comprising a viewing screen (13) of the aircraft, for displaying said optimum flight trajectory (TV).

12. The device according to claim 10,
characterized in that said fourth means comprise means for transmitting said optimum flight trajectory (TV) to means being external to said device (1).

13. The device according to claim 10,
characterized in that it comprises at least one data base relative to stationary obstacles and at least one data base relative to mobile obstacles.

14. An aircraft,
characterized in that it comprises a device (1) such as specified in claim 10.
